(19) United States
(12) Patent Application Publication
(10) Pub. No.: US 2010/0119374 A1
(43) Pub. Date: May 13, 2010

(54) WIND TURBINE & WIND TURBINE BLADE

(76) Inventor: David Wood, New South Wales (AU)

Correspondence Address: JOEL D. SKINNER, JR.;SKINNER AND ASSOCIATES, 212 COMMERCIAL ST., HUDSON, WI, 54016, US

(21) Appl. No.: 12/448,241

(22) PCT Filed: Dec. 13, 2007
(86) PCT No.: PCT/AU2007/001919

§ 371 Date: Nov. 4, 2009

(30) Foreign Application Priority Data
Dec. 13, 2006 (AU) 2006906944

(51) Int. Cl. F03D 1/06; F03D 11/00

(52) U.S. Cl. 416/223 R; 290/55

(57) ABSTRACT

A wind turbine blade to be mounted to a wind turbine hub configured to be mounted for rotation in a hub plane of rotation so as to generate electricity is provided. The blade extends lengthwise between a hub mounting root end and a blade tip end. The blade extends a blade width between a leading edge and trailing edge such that when mounted to the hub the blade is twisted at the root end by an angle of between 19° to 21° relative to the plane of rotation of the hub and wherein the blade is twisted at a tip end to rotate in a plane parallel to the plane of rotation of the hub to within ±1°.

### FIELD OF THE INVENTION

The present invention relates to wind powered turbines and, in particular to a wind turbine blade and a wind turbine using the blades.

The invention has been developed primarily for use in 2 kW to 10 kW horizontal axis wind turbine electricity generators and will be described hereinafter with reference to this application. However, it will be appreciated that the invention is not limited to this particular field of use.

### BACKGROUND ART

Horizontal axis wind turbines are well known, the windmill being a most exemplary example. The principle of operation of a windmill has been expanded from pumping water or grinding to the generation of electricity. In use, at least a pair of turbine blades are mounted symmetrically about a rotating turbine hub. In response to an incident wind, the hub is caused to rotate. The hub is connected either directly or indirectly to an electrical generator shaft (rotor) such that rotation of the shaft generates an electrical output from the generator.

Wind turbine blade design is commonly based on blade element theory (BET), whether by manufacturers of large or small turbine blades. In the blade element theory, a turbine blade is longitudinally divided into a number of elements and each element is assumed to behave as an aerofoil section at the same velocity and angle of attack.

Once this is done, the lift and drag coefficients for the aerofoil can then be used to determine the torque acting on each element. The sum of the torque on all of the blade elements provides a total torque from which a total power output is derived. Reference is made to the “Wind Energy Handbook”, Burton et al (John Wiley & Sons) 2001, the disclosure of which is incorporated herein in its entirety by cross-reference. An extensive description of blade element theory is provided by Burton et al. and it will be understood that this teaches the determination of the power output and optimisation of the blade shape for maximising the generated power in given wind conditions.

Most large wind turbine (for example 20 kW+) blades have a circular or substantially circular blade root to allow the most secure connection to the wind turbine hub. The blade section gradually transforms to the circular or substantially circular root shape as the blade length decreases and the hub approaches. Unfortunately, such blade designs and arrangements cause an overly significant decrease in starting performance when used on relatively small turbine blades.

### Genesis of the Invention

It is the genesis of the invention to provide a wind turbine that optimises both the starting characteristics of the turbine and the power extracted therefrom at a nominal speed, or to provide a useful alternative.

### SUMMARY OF THE INVENTION

According to a first aspect of the present invention there is provided a wind turbine blade configured to be mounted to a wind turbine hub configured to be mounted for rotation in a hub plane of rotation so as to generate electricity, the blade extending lengthwise between a hub mounting root end and a blade tip end, and extending a blade width between a leading edge and trailing edge, such that when mounted to the hub the blade is twisted at the root end by an angle of between 19° to 21° relative to the plane of rotation of the hub and wherein the blade is twisted at a tip end to rotate in a plane parallel to the plane of rotation of the hub to within ±1°.

According to a second aspect of the present invention there is provided a wind turbine including a turbine hub configured to be rotatably mounted for rotation in a hub plane of rotation so as to inductively generate electricity, and two or more wind turbine blades each according to the first aspect of the invention and being mounted symmetrically about the hub.

According to a third aspect of the invention there is provided a wind turbine blade configured to be mounted to a wind turbine hub configured to be mounted for rotation in a hub plane of rotation so as to generate electricity, the blade extending lengthwise between a hub mounting root end and a blade tip end, and extending a blade width between a leading edge and trailing edge, such that when mounted to the hub the blade is twisted by an angle of between −1° to 25° about a blade longitudinal axis extending lengthwise along the blade relative to the plane of rotation of the hub and wherein the blade tip end is configured to rotate in a plane parallel to the plane of rotation of the hub to within ±1°.

According to another aspect of the invention there is provided a wind turbine blade configured to be mounted to a wind turbine hub configured to be mounted for rotation in a hub plane of rotation so as to generate electricity, the blade extending lengthwise between a hub mounting root end and a blade tip end, and extending a blade width between a leading edge and trailing edge, such that when mounted to the hub the blade is twisted at the root end by an angle of between 19° to 21° relative to the plane of rotation of the hub wherein the turbine blade is twisted by an angle of between −1° to 25° about a blade longitudinal axis extending lengthwise along the blade.

It can therefore be seen that there is provided a wind turbine blade and a horizontal axis wind turbine employing the blades 1 which each advantageously optimise the starting characteristics of a 2 kW to 10 kW horizontal axis wind turbine generator and also optimise the power extracted from the horizontal axis wind turbine generator at a nominal operating rotations speed.

### BRIEF DESCRIPTION OF THE DRAWINGS

A preferred embodiment of the invention will now be described, by way of example only, with reference to the accompanying drawings in which:

FIG. 1 is a schematic top view of a wind turbine blade according to the preferred embodiment;

FIG. 2 is a schematic side view of the blade of FIG. 1;

FIG. 3 is an end view of the blade of FIG. 1;

FIG. 4 is a top view of the blade of FIG. 1 as mounted to one part of a wind turbine hub;

FIG. 5 is a side view of the blade and hub of FIG. 4;

FIG. 6 is an end view of the blade and hub of FIG. 4;

FIG. 7 is a schematic top view of a pair of blades of FIG. 1 mounted to a wind turbine hub;

FIG. 8 is a schematic side view of the blades of FIG. 7;

FIG. 9 is an end view of the blades of FIG. 7;

FIG. 10 is a schematic perspective view of a horizontal axis wind turbine having the blades shown in FIG. 7 mounted thereto;

FIG. 11 is a graph of the chord length as a function of blade length for the blade of FIG. 1; and

FIG. 12 is a graph of the blade twist as a function of blade length for the blade of FIG. 1.

### DETAILED DESCRIPTION

Referring to the drawings generally, it will be appreciated that like reference numerals refer to like components.

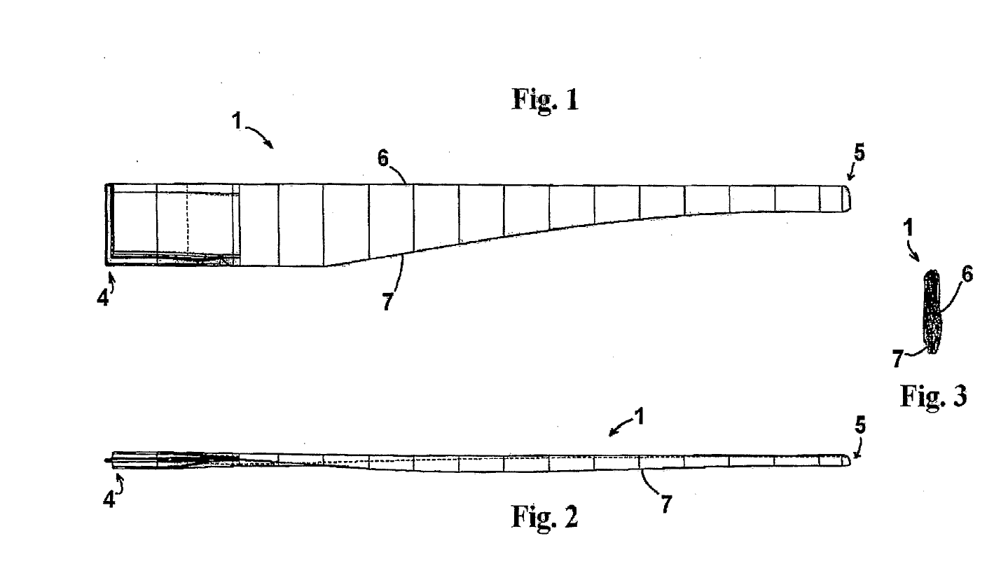

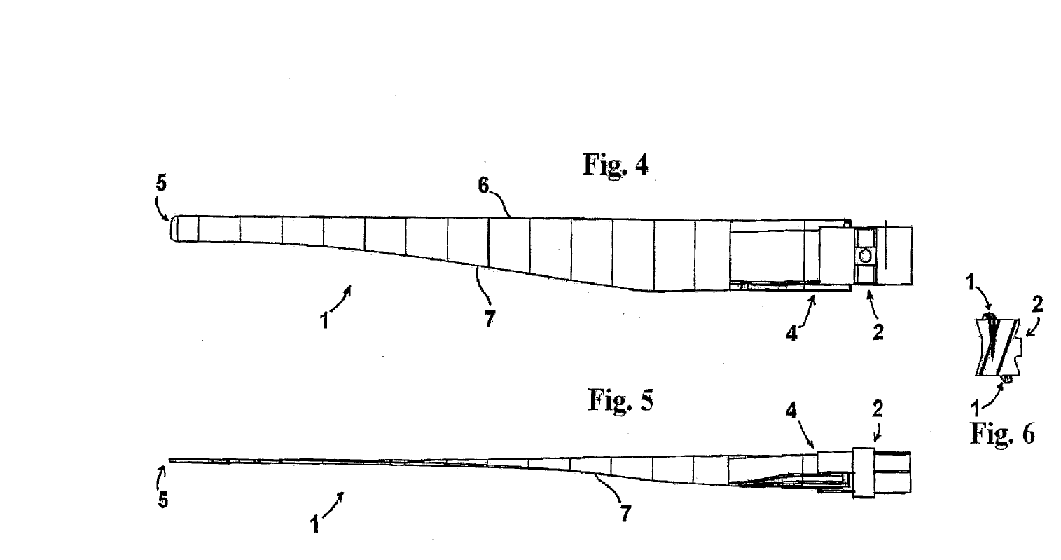

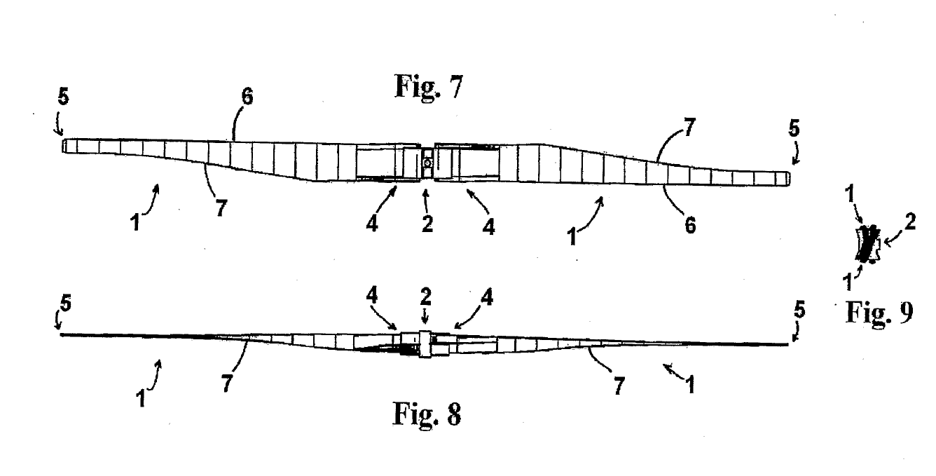

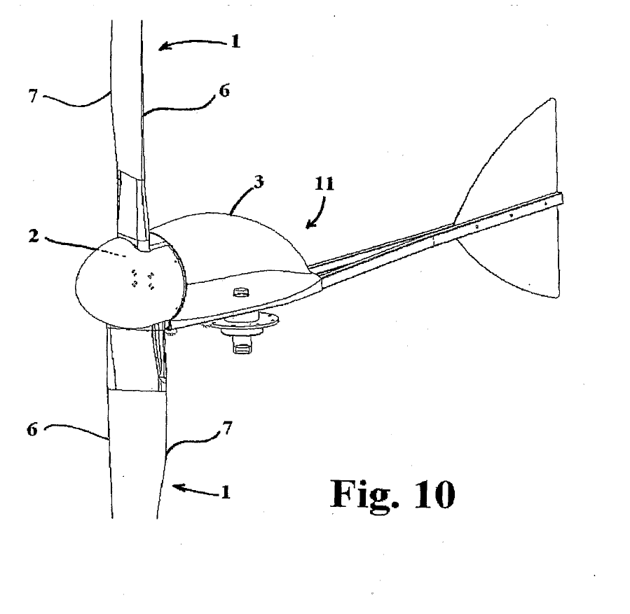

Referring to FIGS. 1 to 3 generally, there is shown various views of a wind turbine blade 1 according to the preferred embodiment of the invention. The blade 1 is configured to be mounted to a horizontal axis wind turbine hub 2 as shown in FIGS. 4 to 9. The hub 2 is configured to be rotatably mounted for rotation in a hub plane of rotation to a horizontal axis of a wind turbine generator 3, as shown in FIG. 10.

Rotation of the hub 2 causes rotation of a 2 kW to 10 kW horizontal axis wind turbine generator 11 which causes an inductive electricity generator rotor (not illustrated) to rotate to thereby inductively generate electricity. An inductive electrical generator 11 is disposed in the horizontal axis wind turbine housing 3 (or nacelle) best shown in FIG. 10.

A pair of turbine blades 1 are symmetrically disposed about the hub 2. The blades 2 are disposed about the hub with a 180° angular spacing and are therefore equi-spaced about the hub axis of rotation. Each wind turbine blade 1 extends lengthwise between a hub mounting root end 4 and a blade tip end 5. Each wind turbine blade also extends a blade width between a blade leading edge 6 and a blade trailing edge 7.

When mounted to the hub 2, each wind turbine blade is twisted at the root end 4 by an angle of between 19° to 21° relative to the plane of rotation of the hub 2.

Each turbine blade 1 is configured such that each blade tip end 5 may be twisted to rotated in a plane of rotation of the hub to within ±1°. In the embodiment shown, each blade tip end 5 is configured to rotate in a plane parallel to the plane of rotation of the hub 2 to within 0.5°.

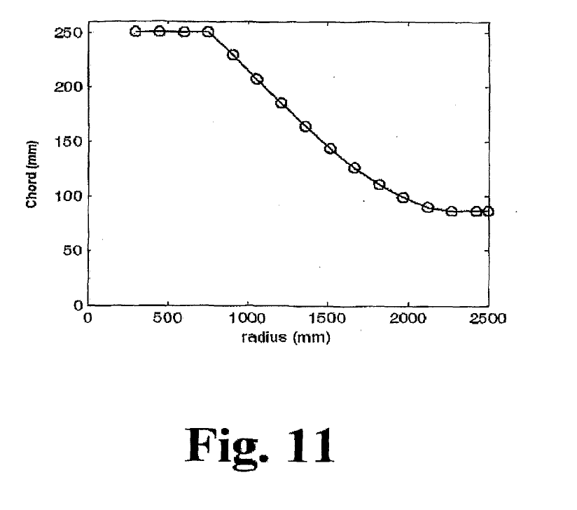

The chord length of each turbine blade 1 varies along the blade length as shown in FIGS. 1 and 2. FIG. 11 is a graph of the chord length of each wind turbine blade as a function of the blade length. The data forming the graph of FIG. 11 is as follows:

| Radius (mm) | Chord (mm) |
|---|---|
| 300.83 | 250.00 |
| 452.50 | 250.00 |
| 604.17 | 250.00 |
| 755.83 | 250.00 |
| 907.50 | 229.66 |
| 1059.17 | 207.31 |
| 1210.83 | 185.17 |
| 1362.50 | 163.84 |
| 1514.17 | 143.91 |
| 1665.83 | 125.99 |
| 1817.50 | 110.67 |
| 1969.17 | 98.55 |
| 2120.83 | 90.23 |
| 2272.50 | 86.31 |
| 2424.17 | 86.31 |
| 2500.00 | 86.31 |

It can be seen that the chord length of each turbine blade 1 is substantially constant at the blade root end 4 and the chord length is also substantially constant at the blade tip end 5. In this preferred embodiment, the chord length of each turbine blade 1 is constant over approximately the first 33% of the length of the turbine blade 1 from the blade root end 4 towards the blade tip end 5. The chord length of each turbine blade is also substantially constant over approximately 6% of the length of the turbine blade 1 from the blade tip end 5 toward the blade root end 4.

In the preferred embodiment of the blade 1 shown in FIGS. 1 to 9, each blade length from the blade root end 4 to the blade tip end 5 is 2.5 meters. The maximum chord length, as shown in FIG. 11, is 250 mm at the blade root end 4 and about 90 mm at the tip end 5 of each blade 1. Although not clearly shown, the hub mounting root end 4 of each blade 1 is substantially rectangular in cross-section.

As best shown in FIG. 10, each blade 1 when mounted to the wind turbine hub 2 and horizontal axis wind turbine generator 11 is configured such that each blade leading edge 6 forms a substantially straight line from the hub mounting end 4 to the blade tip end 5. Further, each blade leading edge 6 is configured to be disposed upwind relative to the trailing edge 7 in an “up-wind” wind turbine where the blades 1 are faced directly into the wind. Although not illustrated, it will be appreciated that the horizontal axis wind turbine generator 11 can be a “down-wind” type wind turbine in which the blades face away from the wind and are partly shadowed by the horizontal axis wind turbine generator 11 and/or its support post.

Each wind turbine blade 1 is twisted along a blade longitudinal axis extending lengthwise along the blade 1 by an angle of between −1° and 21° relative to the plane of rotation of the hub 2. In the preferred embodiment shown, each wind turbine blade 1 is twisted at the blade root end 4 by an angle of 20° with respect to the plane of rotation of the hub 2. Each wind turbine blade 1 is twisted at the blade tip 5 end by an angle of between −0.5° to 0° relative to the plane of rotation of the hub.

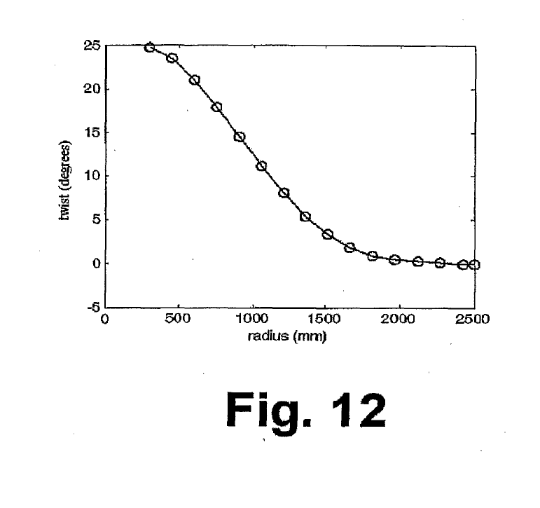

FIG. 12 shows the blade twist relative to the plane of rotation of the blades 1 when 25, mounted to the hub 2 and the horizontal axis wind turbine generator 11, shown in FIG. 10 for example. The data forming the graph of FIG. 11 is as follows:

| Radius (mm) | Twist (°) |
|---|---|
| 300.83 | 24.73 |
| 452.50 | 23.40 |
| 604.17 | 20.95 |
| 755.83 | 17.84 |
| 907.50 | 14.44 |
| 1059.17 | 11.07 |
| 1210.83 | 7.97 |
| 1362.50 | 5.33 |
| 1514.17 | 3.25 |
| 1665.83 | 1.76 |
| 1817.50 | 0.83 |
| 1969.17 | 0.36 |
| 2120.83 | 0.18 |
| 2272.50 | 0.05 |
| 2424.17 | −0.10 |
| 2500.00 | −0.16 |

In the preferred embodiment, each wind turbine blade 1 is preferably moulded from fibreglass, however, any preferred wind turbine blade construction techniques can be employed. Likewise, it will be appreciated that the blade length can be any preferred and that any preferred inductive electrical generator or horizontal axis wind turbine generator can be used. It will be appreciated that active or passive yaw control of the turbine generator 11 can be employed as desired, as can any preferred gearbox mechanism with any preferred gearbox ratio, or the hub 2 may be directly rotatably mounted to the horizontal axis wind turbine generator if desired.

It can therefore be seen that the wind turbine blade 1, and the horizontal axis wind turbine 11 employing the blades 1, advantageously optimise the starting characteristics of a 2 kW to 10 kW horizontal axis wind turbine generator 11. The horizontal axis wind turbine generator 11 also advantageously optimises the power extracted from the horizontal axis wind turbine generator 11 at a nominal operating rotations speed.

The foregoing describes only one embodiment of the present invention and modifications, obvious to those skilled in the art, can be made thereto without departing from the scope of the present invention.

1. An elongate wind turbine blade including:
a blade root end for mounting on a rotatable hub of a wind turbine;
an opposite, blade tip end;
a first blade portion extending from a first position at or adjacent the blade root end to a second position between the blade ends, the blade having a substantially constant first chord length along the first blade portion;
a second blade portion extending from a third position at or adjacent the blade tip end to a fourth position between the second and third positions, the blade having a substantially constant second chord length along the second blade portion, the second chord length being less than the first chord length;
a third blade portion extending from the first blade portion to the second blade portion, the chord length decreasing along the third blade portion in a direction towards the blade tip end;
wherein the blade root end is configured to be mounted on a said hub at an attachment angle to a plane of rotation of the blade, and
wherein the blade tip end is configured such that, when the blade root end is so mounted on a said hub, the blade tip end is at a twist angle to said plane of rotation, the twist angle being less than the attachment angle.

2. An elongate wind turbine blade according to claim 1 wherein the length of the first blade portion is at least 20 percent of the total blade length, but does not exceed 40 percent of the total blade length.

3. An elongate wind turbine blade according to claim 1 or claim 2 wherein the length of the first blade portion is at least 20 percent of the total blade length but does not exceed 35 percent of the total blade length.

4. An elongate wind turbine blade according to any one of the preceding claims wherein the length of the first blade portion is at least 21 percent of the total blade length but does not exceed 33 percent of the total blade length.

5. An elongate wind turbine blade according to any one of the preceding claims wherein the length of the second blade portion is at least 5 percent of the total blade length but does not exceed 25 percent of the total blade length.

6. An elongate wind turbine blade according to any one of the preceding claims wherein the length of the second blade portion is at least 5 percent of the total blade length but not exceeding 20 percent of the total blade length.

7. An elongate wind turbine blade according to any one of the preceding claims wherein the length of the second blade portion is at least 6 percent of the total blade length but does not exceed 10 percent of the total blade length.

8. An elongate wind turbine blade according to any one of the preceding claims wherein the angle of the blade to said plane of rotation decreases from said blade root end to said blade tip end.

9. An elongate wind turbine blade according to any one of the preceding claims wherein said attachment angle is in the range from 19 degrees to 25 degrees.

10. An elongate wind turbine blade according to any one of the preceding claims wherein said attachment angle is in the range from 19 degrees to 21 degrees.

11. An elongate wind turbine blade according to any one of the preceding claims wherein said attachment angle is substantially 20 degrees.

12. An elongate wind turbine blade according to any one of the preceding claims wherein said twist angle is in the range from −1 degree to 1 degree.

13. An elongate wind turbine blade according to any one of the preceding claims wherein said twist angle is in the range from −0.5 degrees to 0 degrees.

14. An elongate wind turbine blade according to any one of the preceding claims, having a leading edge in relation to the direction of rotation of the blade when the blade is mounted to a said hub, the leading edge substantially extending along a straight line from the blade root end to the blade tip end.

15. An elongate wind turbine blade according to any one of the preceding claims wherein the blade root end is of substantially rectangular shape.

16. A wind turbine according to claim 1 wherein the chord lengths at each of a plurality of predetermined positions along the length of the blade are as follows, where each predetermined position is stated as a radius from an axis of rotation of a said hub:
at radius 300.83 mm, the chord is 250.00 mm;
at radius 452.50 mm, the chord is 250.00 mm;
at radius 604.17 mm, the chord is 250.00 mm;
at radius 755.83 mm, the chord is 250.00 mm;
at radius 907.50 mm, the chord is 229.66 mm;
at radius 1059.17 mm, the chord is 207.31 mm;
at radius 1210.83 mm, the chord is 185.17 mm;
at radius 1362.50 mm, the chord is 163.84 mm;
at radius 1514.17 mm, the chord is 143.91 mm;
at radius 1665.83 mm, the chord is 125.99 mm;
at radius 1817.50 mm, the chord is 110.67 mm;
at radius 1969.17 nun, the chord is 98.55 mm;
at radius 2120.83 mm, the chord is 90.23 mm;
at radius 2272.50 mm, the chord is 86.31 mm;
at radius 2424.17 mm, the chord is 86.31 mm; and
at radius 2500.00 mm, the chord is 86.31 mm.

17. A wind turbine according to claim 1 wherein the angles to said plane of rotation, of portions of the blade each portion being at a respective predetermined position along the length of the blade, are as follows, where each predetermined position is stated as a radius from an axis of rotation of a said hub:
at radius 300.83 mm, the angle is 24.73 mm;
at radius 452.50 mm, the angle is 23.40 mm;
at radius 604.17 mm, the angle is 20.95 mm;
at radius 755.83 mm, the angle is 17.84 mm;
at radius 907.50 mm, the angle is 14.44 mm;
at radius 1059.17 mm, the angle is 11.07 mm;
at radius 1210.83 mm, the angle is 7.97 mm;
at radius 1362.50 mm, the angle is 5.33 mm;
at radius 1514.17 mm, the angle is 3.25 mm;
at radius 1665.83 mm, the angle is 1.76 mm;
at radius 1817.50 mm, the angle is 0.83 mm;
at radius 1969.17 mm, the angle is 0.36 mm;
at radius 2120.83 mm, the angle is 0.18 mm;
at radius 2272.50 mm, the angle is 0.05 mm;
at radius 2424.17 mm, the angle is −0.10 mm; and
at radius 2500.00 mm, the angle is −0.16 mm.

18. A wind turbine including:
a rotatable turbine hub; and
a plurality of turbine blades attached to the hub, each blade being according to any of one of claims 1 to 17.

19. A wind turbine according to claim 18 configured for generation of electricity on rotation of the hub.

20. A wind turbine according to claim 18 or claim 19, including a pair of said blades mounted to, and symmetrical about, the hub.

21. A wind turbine according to claim 18 or claim 19, including three said blades mounted to the hub so as to be evenly angularly spaced about the hub.
